(19) United States
(12) Patent Application Publication
(10) Pub. No.: US 2023/0422294 A1
(43) Pub. Date: Dec. 28, 2023

(54) METHOD FOR DATA TRANSMISSION, TERMINAL, AND CHIP

(71) Applicant: UNISOC (CHONGQING) TECHNOLOGIES CO., LTD., Chongqing (CN)

(72) Inventors: Cong LIN, Chongqing (CN); Lan LUO, Chongqing (CN)

(73) Assignee: UNISOC (CHONGQING) TECHNOLOGIES CO., LTD., Chongqing (CN)

(21) Appl. No.: 18/254,483

(22) PCT Filed: Nov. 17, 2021
(86) PCT No.: PCT/CN2021/131301

§ 371 Date: May 25, 2023

(30) Foreign Application Priority Data
Nov. 26, 2020 (CN) 202011349417.0
Nov. 26, 2020 (CN) 202011354339.3

(51) Int. Cl. H04W 72/566; H04W 76/10; H04W 74/08; H04W 72/21

(52) U.S. Cl. CPC H04W 72/569; H04W 76/10; H04W 74/0833; H04W 72/21

(57) ABSTRACT

A method for data transmission, a terminal, and a chip are provided. The method for data transmission is performed by a terminal. The method for data transmission includes: receiving scheduling request (SR) configuration information transmitted by a base station (BS), where the SR configuration information contains a maximum number of SR transmissions; adjusting the maximum number of SR transmissions according to a priority of data to-be-transmitted; and transmitting an SR to request an uplink (UL) grant resource for transmission of the data to-be-transmitted, and initiating a random access request to re-request the UL grant resource in response to a number of SR transmissions reaching the maximum number of SR transmissions.

### CROSS-REFERENCE TO RELATED APPLICATION(S)

This application is a National Stage of International Application No. PCT/CN2021/131301, field Nov. 17, 2021, which claims priority to Chinese Patent Application No. 202011354339.3, filed Nov. 26, 2020, and Chinese Patent Application No. 202011349417.0, filed Nov. 26, 2020, the entire disclosures of which are hereby incorporated by reference.

### TECHNICAL FIELD

This application relates to the field of communications technologies, and particularly to a method for data transmission, a terminal, and a chip.

### BACKGROUND

With the development of mobile communication technology, people use data services more and more frequently, and the data service rate will directly affect user experience. In an actual network environment, when a terminal is in a connected state, if the terminal has uplink (UL) data to be transmitted but has no UL grant, the terminal needs to request the UL grant from a base station through an scheduling request (SR), and the terminal can transmit data on an allocated UL resource upon reception of the UL grant issued by the base station.

According to 10.1.5 of the 3GPP 36.213 protocol and a summary of a large amount of test configurations on the real network, the maximum number dsr-TransMax of transmissions of SR configuration is 64, and the maximum SR period can be configured to be 80 ms. According to the configuration described above, the maximum number of SR transmissions requires 64*80 ms=5120 ms (the case of prohibiting a timer sr-ProhibitTimer is not considered). If the terminal still has not obtained the UL grant when SR transmission reaches the maximum number of SR transmissions, the terminal needs to request the UL grant by initiating contention-based random access.

As illustrated in FIG. 1, a terminal transmits a random access preamble to a base station through a physical random access channel (PRACH) to request a UL grant. According to 5.1 of the 3GPP 36.3.2.1 protocol and a summary of a large amount of test configurations on the real network, a maximum number preambleTransMax of preamble transmissions is configured to be 10 or greater, the size ra-ResponseWindowSize of a listening window is configured to be sf10, the maximum number maxHARQ-Msg3Tx of Msg3 transmissions is configured to be 5 or greater, and a duration of a contention resolution timer (i.e., mac-ContentionResolutionTimer) is configured to be sf64. In the case that Msg1 to Msg3 are transmitted/received normally, assuming that a duration from receiving a random access response (RAR) to transmitting Msg3 after the preamble is transmitted is sf6, preamble transmission reaching the maximum number of preamble transmissions requires 10*(sf64+sf6)=700 ms. If preamble transmission reaches the maximum number of preamble transmissions and a radio resource control (RRC) layer receives a random access problem indication transmitted by a media access control (MAC) layer, it is considered that radio link failure occurs, and the terminal will initiate an RRC connection re-establishment process to resume the service.

In sum, according to a general UL grant request process, if the terminal has not obtained the UL grant before actively initiating re-establishment to resume the service, it will take about 6 s. Time consumption of service interruption, or time consumption of service establishment latency (i.e., 6 s), or service establishment timeout failure will seriously affect the service and user experience.

### SUMMARY

A first aspect of the disclosure provides a method for data transmission. The method is performed by a terminal. The method includes: receiving scheduling request (SR) configuration information transmitted by a base station (BS), the SR configuration information containing a maximum number of SR transmissions; adjusting the maximum number of SR transmissions according to a priority of data to-be-transmitted; and transmitting an SR to request an uplink (UL) grant resource for transmission of the data to-be-transmitted, and initiating a random access request to re-request the UL grant resource in response to a number of SR transmissions reaching the maximum number of SR transmissions.

A second aspect of the disclosure provides a terminal. The terminal includes a transceiver, at least one processor, and a memory. The at least one processor is in communication connection with the transceiver. The memory is in communication connection with the at least one processor, and stores instructions executable by the at least one processor. The instructions, when executed by the at least one processor, are operable with the at least one processor to execute the method for data transmission in the first aspect.

A third aspect of the disclosure provides a chip. The chip includes a processor. The processor is configured to invoke and run programs stored in a memory to cause a device equipped with the chip to execute the method for data transmission in the first aspect.

### BRIEF DESCRIPTION OF THE DRAWINGS

FIG. 1 is a flowchart of random access in the related art.

FIG. 2 is an exemplary application-scenario diagram provided in an implementation of the disclosure.

FIG. 3 is a schematic flowchart illustrating a method for data transmission provided in implementation 1 of the disclosure.

FIG. 4 is a schematic flowchart illustrating a method for data transmission provided in implementation 2 of the disclosure.

FIG. 5 is a schematic flowchart illustrating a method for data transmission provided in implementation 3 of the disclosure.

FIG. 6 is a schematic structural diagram illustrating a system for data transmission provided in implementation 4 of the disclosure.

FIG. 7 is a schematic structural diagram illustrating a system for data transmission provided in implementation 5 of the disclosure.

FIG. 8 is a schematic structural diagram illustrating a terminal provided in implementations of the disclosure.

FIG. 9 is a schematic structural diagram illustrating a chip provided in implementations of the disclosure.

### DETAILED DESCRIPTION

Hereinafter, the disclosure will be further depicted with reference to implementations, and these implementations, however, are not intended to limit the disclosure.

Exemplary application scenarios of implementations of the disclosure will be introduced below.

Technical solutions of the disclosure can be applicable to a fifth generation (5G) communication system, a fourth generation (4G) communication system, a third generation (3G) communication system, and various future new communication systems, such as a sixth generation (6G) communication system and a seventh generation (7G) communication system. The technical solutions of the disclosure can also be applicable to different network architectures, including but not limited to a relay network architecture, a dual-link architecture, a vehicle-to-everything communication architecture, and other architectures, which is not limited in implementations of the disclosure. The base station of implementations of the disclosure may be a base station of a communication network providing communication services for terminals, including a base station of a radio access network (RAN), a base station controller of a RAN, and equipment at a core network side. The base station controller herein is a device for managing base stations, such as a base station controller (BSC) in a second generation (2G) network and a radio network controller (RNC) in a 3G network, and may also refer to a device for controlling and managing base stations in a future new communication system.

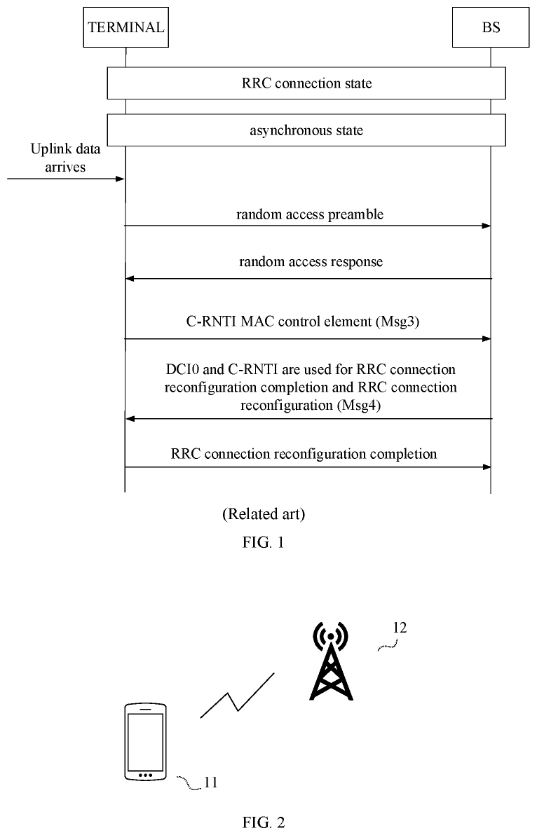

In an optional implementation, FIG. 2 is an exemplary application-scenario diagram provided in an implementation of the disclosure. As illustrated in FIG. 2, data communication is performed between a terminal 11 and a base station 12. The terminal 11 of implementations of the disclosure may refer to various forms of user equipment (UE), access terminals, subscriber units, subscriber stations, mobile stations (MS), remote stations, remote terminals, mobile equipment, user terminals, terminal equipment, wireless communication equipment, user agents, or user devices. The terminal equipment may also be a cellular telephone, a cordless telephone, a session initiation protocol (SIP) telephone, a wireless local loop (WLL) station, a personal digital assistant (PDA), a handheld device with a wireless communication function, a computing device, other processing devices coupled with a wireless modem, an in-vehicle device, a wearable device, terminal equipment in a future 5G network or terminal equipment in a future evolved public land mobile network (PLMN), etc., which is not limited in implementations of the disclosure.

The base station (BS) 12 of implementations of the disclosure may also be referred to as a base station device, and is a device deployed in a RAN to provide a wireless communication function. For example, equipment that provides a base station function in the 2G network includes a base transceiver station (BTS), equipment that provides a base station function in the 3G network includes a NodeB, equipment that provides a base station function in the 4G network includes an evolved NodeB (eNB), equipment that provides a base station function in a wireless local area network (WLAN) is an access point (AP), equipment that provides a base station function in 5G new radio (NR) is a gNodeB (gNB) and a next generation eNB (ng-eNB), where the gNB communicates with a terminal through an NR technology, the ng-eNB communicates with a terminal through an evolved universal terrestrial radio access (E-UTRA) technology, and the gNB and the ng-eNB can be connected to a 5G core network (CN). The BS of implementations of the disclosure also includes equipment that provides a base station function in a future new communication system, which is not limited in implementations of the disclosure.

The following definitions are given in implementations of the disclosure: one-way communication link from an access network to a terminal is a downlink, data transmitted on the downlink is downlink data, and a transmission direction of the downlink data is referred to as a downlink direction; one-way communication link from a terminal to an access network is an uplink, data transmitted on the uplink is uplink data, and a transmission direction of the uplink data is referred to as an uplink direction.

Implementation 1

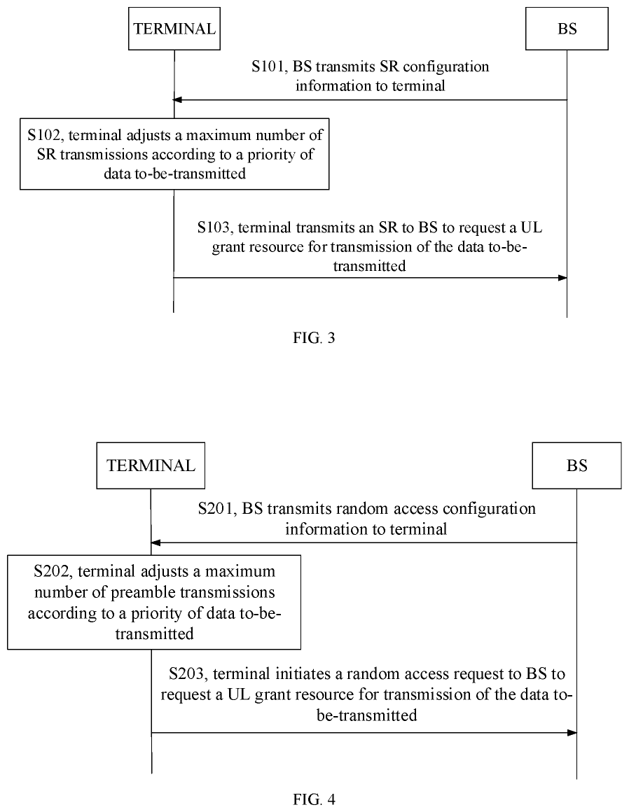

FIG. 3 is a schematic flowchart illustrating a method for data transmission provided in this implementation. The method can be executed by a system for data transmission. The system may be implemented by software and/or hardware, and may include all or part of a terminal and a BS. The method for data transmission is depicted by taking the terminal and the BS as execution subjects below. As illustrated in FIG. 3, the method for data transmission of this implementation includes the following.

At S101, the BS transmits scheduling request (SR) configuration information to the terminal, where the SR configuration information contains a maximum number dsr-TransMax of SR transmissions. In a specific implementation, the terminal receives the SR configuration information through a downlink channel.

At S102, the terminal adjusts the maximum number (i.e., quantity, how many) of SR transmissions according to a priority of data to-be-transmitted.

It is to be noted that, in the operations at S102, for data to-be-transmitted with different priorities, the maximum number of SR transmissions configured by the BS may be adjusted to be the same or different. As an example, for data to-be-transmitted with a priority of A1, the maximum number of SR transmissions configured by the BS is adjusted to C1; for data to-be-transmitted with a priority of A2, the maximum number of SR transmissions configured by the BS is adjusted to C2.

In an optional implementation, the SR configuration information further contains an SR period. The operations at S102 specifically include operations at S102a and operations at S102b. At S102a, if the priority of the data to-be-transmitted is higher than a preset level, a target number of transmissions is calculated according to a preset timeout duration and the SR period. At S102b, the maximum number of SR transmissions is adjusted to the target number of transmissions.

In this implementation, the maximum number of SR transmissions is adjusted by limiting the timeout duration. Specifically, the target number of transmissions is obtained by dividing the preset timeout duration by the SR period configured by the BS. As an example, the preset timeout duration SR_TimerTH is set to 640 ms, the maximum number of SR transmissions configured by the BS is 64, and the SR period is 40 ms, according to the preset timeout duration and the SR period, the target number of transmissions is calculated as 640 ms/40 ms=16, and thus, the maximum number of SR transmissions configured by the BS is adjusted from 64 to 16.

In an optional implementation of the operations at S102, if the priority of the data to-be-transmitted is higher than a preset level, the maximum number of SR transmissions is decreased. The preset level may be set according to actual conditions.

At S103, the terminal transmits an SR to the BS to request an uplink (UL) grant resource for transmission of the data to-be-transmitted. When the number of SR transmissions reaches the maximum number of SR transmissions, the terminal initiates a random access request to the BS to re-request the UL grant resource.

It is to be noted that, before the number of SR transmissions reaches the maximum number of SR transmissions, if the terminal has received the UL grant resource transmitted by the BS, the terminal transmits the data to-be-transmitted on the UL grant resource without initiating a random access request to the BS.

In addition, in the case of poor channel environment quality, it is difficult to guarantee a success rate of SR transmission and downlink reception. In order to avoid frequently triggering radio resource control (RRC) re-establishment, when a channel quality of the terminal is lower than a threshold, the maximum number of SR transmissions configured by the BS for the terminal will not be adjusted. As an example, if a reference signal receiving power (RSRP) of the terminal is lower than a power threshold, the configured maximum number of SR transmissions is not adjusted. As another example, if a signal to interference plus noise ratio (SINR) of the terminal is lower than a ratio threshold, the configured maximum number of SR transmissions is not adjusted.

In this implementation, the maximum number of SR transmissions configured by the BS is adjusted according to the priority of the data to-be-transmitted, so that the terminal can adjust, according to its own UL service, time consumption of requesting the UL grant resource, instead of completely depending on configuration of the BS, thereby improving flexibility.

Further, when the priority of the data to-be-transmitted is higher than the preset level, the maximum number of SR transmissions configured by the BS is decreased, which can realize rapid initiation of random access to re-request the UL grant resource when the terminal does not obtain the UL grant resource after the SR is transmitted, thereby reducing time consumption of requesting the UL grant resource, reducing a service interruption duration or service establishment latency, and improving user experience when using the terminal.

Implementation 2

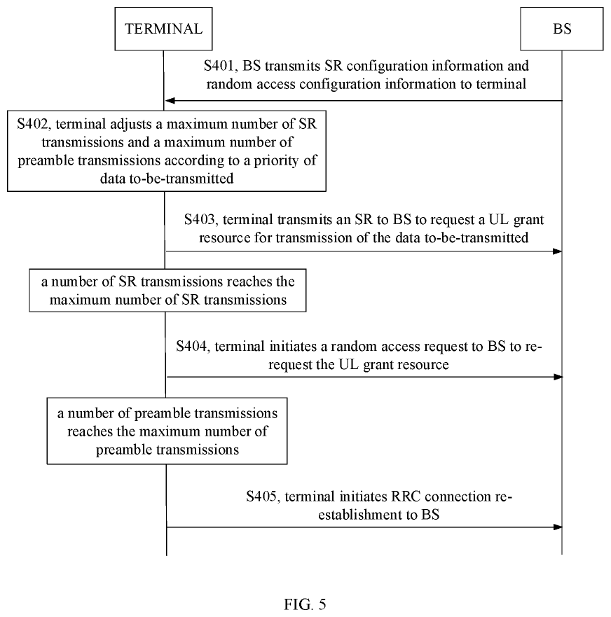

FIG. 4 is a schematic flowchart illustrating a method for data transmission provided in this implementation. The method can be executed by a system for data transmission. The system may be implemented by software and/or hardware, and may include all or part of a terminal and a BS. The method for data transmission is depicted by taking the terminal and the BS as execution subjects below. As illustrated in FIG. 4, the method for data transmission of this implementation includes the following.

At S201, the BS transmits random access configuration information to the terminal, where the random access configuration information contains a maximum number preambleTransMax of preamble transmissions. In a specific implementation, the terminal receives the random access configuration information through a downlink channel.

At S202, the terminal adjusts the maximum number of preamble transmissions according to a priority of data to-be-transmitted.

It is to be noted that, in the operations at S202, for data to-be-transmitted with different priorities, the maximum number of preamble transmissions configured by the BS may be adjusted to be the same or different. As an example, for data to-be-transmitted with a priority of A1, the maximum number of preamble transmissions configured by the BS is adjusted to C1; for data to-be-transmitted with a priority of A2, the maximum number of preamble transmissions configured by the BS is adjusted to C2.

In an optional implementation of the operations at S202, if the priority of the data to-be-transmitted is higher than a preset level, the maximum number of preamble transmissions is decreased. The preset level may be set according to actual conditions.

At S203, the terminal initiates a random access request to the BS to request a UL grant resource for transmission of the data to-be-transmitted, and initiates RRC connection re-establishment to the BS when the number of preamble transmissions reaches the maximum number of preamble transmissions.

It is to be noted that, before the number of preamble transmissions reaches the maximum number of preamble transmissions, if the terminal has received the UL grant resource transmitted by the BS, the terminal transmits the data to-be-transmitted on the UL grant resource without initiating RRC connection re-establishment to the BS.

In addition, in the case of poor channel environment quality, it is difficult to guarantee a success rate of preamble transmission and downlink reception. In order to avoid frequently triggering RRC re-establishment, when a channel quality of the terminal is lower than a threshold, the maximum number of preamble transmissions configured by the BS for the terminal will not be adjusted. As an example, if an RSRP of the terminal is lower than a power threshold, the configured maximum number of preamble transmissions is not be adjusted. As another example, if an SINR of the terminal is lower than a ratio threshold, the configured maximum number of preamble transmissions is not adjusted.

In this implementation, the maximum number of preamble transmissions configured by the BS is adjusted according to the priority of the data to-be-transmitted, so that the terminal can adjust, according to its own UL service, time consumption of requesting the UL grant resource, instead of completely depending on configuration of the BS, thereby improving flexibility.

Further, when the priority of the data to-be-transmitted is higher than the preset level, the maximum number of preamble transmissions configured by the BS is decreased, which can realize rapid initiation of RRC connection re-establishment to resume the service when the terminal does not obtain the UL grant resource after the random access request is initiated, thereby reducing time consumption of requesting the UL grant resource, reducing a service interruption duration or service establishment latency, and improving user experience when using the terminal.

Implementation 3

FIG. 5 is a schematic flowchart illustrating a method for data transmission provided in this implementation. The method can be executed by a system for data transmission. The system may be implemented by software and/or hardware, and may include all or part of a terminal and a BS. The method for data transmission is depicted by taking the terminal and the BS as execution subjects below. As illustrated in FIG. 5, the method for data transmission of this implementation includes the following.

At S401, the BS transmits SR configuration information and random access configuration information to the terminal, where the SR configuration information contains a maximum number dsr-TransMax of SR transmissions, and the random access configuration information contains a maximum number preambleTransMax of preamble transmissions. In a specific implementation, the terminal receives the SR configuration information and the random access configuration information through a downlink channel.

At S402, the terminal adjusts the maximum number of SR transmissions and the maximum number of preamble transmissions according to a priority of data to-be-transmitted.

It is to be noted that, in the operations at S402, for data to-be-transmitted with different priorities, the maximum number of SR transmissions configured by the BS may be adjusted to be the same, and the maximum number of preamble transmissions configured by the BS may be adjusted to be the same. For data to-be-transmitted with different priorities, the maximum number of SR transmissions configured by the BS may also be adjusted to be different, and the maximum number of preamble transmissions configured by the BS may also be adjusted to be different.

In an optional implementation, the SR configuration information further contains an SR period. The operations at S402 specifically include operations at S402a and operations at S402b. At S402a, if the priority of the data to-be-transmitted is higher than a preset level, a target number of transmissions is calculated according to a preset timeout duration and the SR period. At S402b, the maximum number of SR transmissions and the maximum number of preamble transmissions are adjusted to the target number of transmissions.

In this implementation, the maximum number of SR transmissions is adjusted by limiting the timeout duration. Specifically, the target number of transmissions is obtained by dividing the preset timeout duration by the SR period configured by the BS. As an example, the preset timeout duration SR_TimerTH is set to 640 ms, the maximum number of SR transmissions configured by the BS is 64, and the SR period is 40 ms, according to the preset timeout duration and the SR period, the target number of transmissions is calculated as 640 ms/40 ms=16, and thus, the maximum number of SR transmissions configured by the BS is adjusted from 64 to 16.

In an optional implementation of the operations at S402, if the priority of the data to-be-transmitted is higher than a preset level, the maximum number of SR transmissions and the maximum number of preamble transmissions are decreased. The preset level may be set according to actual conditions.

At S403, the terminal transmits an SR to the BS to request a UL grant resource for transmission of the data to-be-transmitted. When the number of SR transmissions reaches the maximum number of SR transmissions, the terminal performs operations at S404.

At S404, the terminal initiates a random access request to the BS to re-request the UL grant resource. When the number of preamble transmissions reaches the maximum number of preamble transmissions, the terminal performs operations at S405.

At S405, the terminal initiates RRC connection re-establishment to the BS.

It is to be noted that, before the number of SR transmissions reaches the maximum number of SR transmissions, if the terminal has received the UL grant resource transmitted by the BS, the terminal transmits the data to-be-transmitted on the UL grant resource without initiating a random access request to the BS. Before the number of preamble transmissions reaches the maximum number of preamble transmissions, if the terminal has received the UL grant resource transmitted by the BS, the terminal transmits the data to-be-transmitted on the UL grant resource without initiating a re-establishment process.

In this implementation, the maximum number of SR transmissions and the maximum number of preamble transmissions configured by the BS are adjusted according to the priority of the data to-be-transmitted, so that the terminal can adjust, according to its own UL service, time consumption of requesting the UL grant resource, instead of completely relying on configuration of the BS, thereby improving flexibility.

Further, when the priority of the data to-be-transmitted is higher than the preset level, the maximum number of SR transmissions and the maximum number of preamble transmissions configured by the BS are decreased, which can realize rapid initiation of random access when the terminal does not obtain the UL grant resource after the SR is transmitted, and realize rapid initiation of re-establishment to resume the service when the terminal does not obtain the UL grant resource through random access, thereby reducing time consumption of requesting the UL grant resource, reducing a service interruption duration or service establishment latency, and improving user experience when using the terminal.

Implementation 4

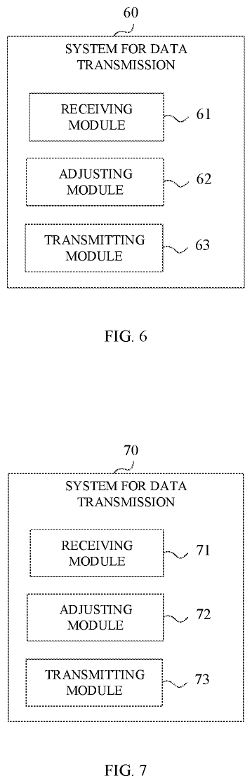

FIG. 6 is a schematic structural diagram illustrating a system for data transmission provided in this implementation. As illustrated in FIG. 6, a system 60 for data transmission of this implementation includes a receiving module 61, an adjusting module 62, and a transmitting module 63. The receiving module is configured to receive SR configuration information transmitted by a BS, where the SR configuration information contains a maximum number of SR transmissions. The adjusting module is configured to adjust the maximum number of SR transmissions according to a priority of data to-be-transmitted. The transmitting module is configured to transmit an SR to request a UL grant resource for transmission of the data to-be-transmitted, and initiate a random access request to re-request the UL grant resource in response to a number of SR transmissions reaching the maximum number of SR transmissions.

In an optional implementation, the SR configuration information further contains an SR period, and the adjusting module specifically includes a judging unit, a calculation unit, and an adjusting unit. The judging unit is configured to determine whether the priority of the data to-be-transmitted is higher than a preset level, and call the calculation unit in response to the priority of the data to-be-transmitted being higher than the preset level. The calculation unit is configured to calculate a target number of transmissions according to a preset timeout duration and the SR period. The adjusting unit is configured to adjust the maximum number of SR transmissions to the target number of transmissions.

In an optional implementation, the adjusting module is specifically configured to decrease the maximum number of SR transmissions, in response to the priority of the data to-be-transmitted being higher than a preset level.

In an optional implementation, the receiving module is further configured to receive random access configuration information transmitted by the BS, where the random access configuration information contains a maximum number of preamble transmissions; the adjusting module is further configured to adjust the maximum number of preamble transmissions according to the priority of the data to-be-transmitted; and the transmitting module is further configured to initiate RRC connection re-establishment, in response to a number of preamble transmissions reaching the maximum number of preamble transmissions.

In an optional implementation, the adjusting module is specifically configured to decrease the maximum number of preamble transmissions, in response to the priority of the data to-be-transmitted being higher than a preset level.

In this implementation, the maximum number of SR transmissions and/or the maximum number of preamble transmissions configured by the BS are adjusted according to the priority of the data to-be-transmitted, so that the terminal can adjust, according to its own UL service, time consumption of requesting the UL grant resource, instead of completely relying on configuration of the BS, thereby improving flexibility.

Further, when the priority of the data to-be-transmitted is higher than the preset level, the maximum number of SR transmissions and/or the maximum number of preamble transmissions configured by the BS are decreased, which can realize rapid initiation of random access when the terminal does not obtain the UL grant resource after the SR is transmitted, and realize rapid initiation of re-establishment to resume the service when the terminal does not obtain the UL grant resource through random access, thereby reducing time consumption of requesting the UL grant resource, reducing a service interruption duration or service establishment latency, and improving user experience when using the terminal.

Implementation 5

FIG. 7 is a schematic structural diagram illustrating a system for data transmission provided in this implementation. As illustrated in FIG. 7, a system 70 for data transmission of this implementation includes a receiving module 71, an adjusting module 72, and a transmitting module 73. The receiving module is configured to receive random access configuration information transmitted by a BS, where the random access configuration information contains a maximum number of preamble transmissions. The adjusting module is configured to adjust the maximum number of preamble transmissions according to a priority of data to-be-transmitted. The transmitting module is configured to initiate a random access request to request a UL grant resource for transmission of the data to-be-transmitted, and initiate RRC connection re-establishment in response to a number of preamble transmissions reaching the maximum number of preamble transmissions.

In an optional implementation, the adjusting module is specifically configured to decrease the maximum number of preamble transmissions, in response to the priority of the data to-be-transmitted being higher than a preset level.

In an optional implementation, the receiving module is further configured to receive SR configuration information transmitted by the BS, where the SR configuration information contains a maximum number of SR transmissions; the adjusting module is further configured to adjust the maximum number of SR transmissions according to the priority of the data to-be-transmitted; and the transmitting module is further configured to transmit an SR to request the UL grant resource for transmission of the data to-be-transmitted, and initiate the random access request to re-request the UL grant resource in response to a number of SR transmissions reaching the maximum number of SR transmissions.

In an optional implementation, the adjusting module is specifically configured to decrease the maximum number of SR transmissions, in response to the priority of the data to-be-transmitted being higher than a preset level.

In an optional implementation, the SR configuration information further contains an SR period, and the adjusting module specifically includes a judging unit, a calculation unit, and an adjusting unit. The judging unit is configured to determine whether the priority of the data to-be-transmitted is higher than a preset level, and call the calculation unit in response to the priority of the data to-be-transmitted being higher than the preset level. The calculation unit is configured to calculate a target number of transmissions according to a preset timeout duration and the SR period. The adjusting unit is configured to adjust the maximum number of SR transmissions to the target number of transmissions.

In this implementation, the maximum number of SR transmissions and/or the maximum number of preamble transmissions configured by the BS are adjusted according to the priority of the data to-be-transmitted, so that the terminal can adjust, according to its own UL service, time consumption of requesting the UL grant resource, instead of completely relying on configuration of the BS, thereby improving flexibility.

Further, when the priority of the data to-be-transmitted is higher than the preset level, the maximum number of SR transmissions and/or the maximum number of preamble transmissions configured by the BS are decreased, which can realize rapid initiation of random access when the terminal does not obtain the UL grant resource after the SR is transmitted, and realize rapid initiation of re-establishment to resume the service when the terminal does not obtain the UL grant resource through random access, thereby reducing time consumption of requesting the UL grant resource, reducing a service interruption duration or service establishment latency, and improving user experience when using the terminal.

Implementation 6

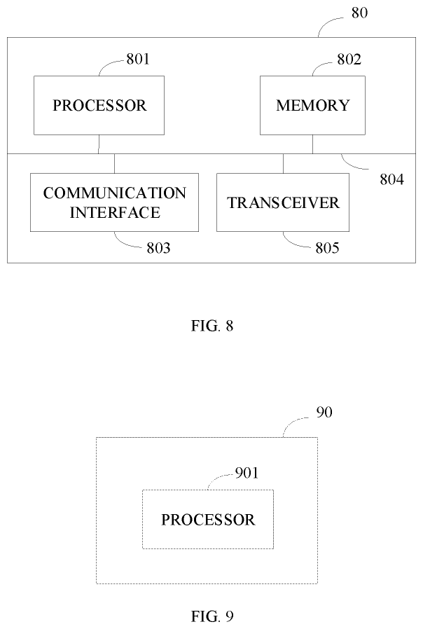

Implementations of the disclosure provide a terminal. As illustrated in FIG. 8, a terminal 80 includes at least one processor 801, a memory 802, a communication interface 803, and a transceiver 805. The processor 801, the memory 802, the communication interface 803, and the transceiver 805 are connected to each other through a bus 804. The memory stores instructions executable by the at least one processor. The instructions, when executed by the at least one processor, are operable with the at least one processor to execute the method for data transmission in implementation 1, implementation 2, or implementation 3.

Implementations of the disclosure provide a chip. As illustrated in FIG. 9, a chip 90 includes a processor 901. The processor is configured to invoke and run programs stored in a memory to cause a device equipped with the chip to execute the method for data transmission in implementation 1, implementation 2, or implementation 3.

Implementations of the disclosure provide a non-transitory computer-readable storage medium. The non-transitory computer-readable storage medium stores computer instructions which are operable with a computer to execute the method for data transmission in implementation 1, implementation 2, or implementation 3.

Specifically, the readable storage medium may include, but is not limited to, a portable disk, a hard disk, a random access memory (RAM), a read-only memory (ROM), an erasable programmable ROM, an optical storage device, a magnetic storage device, or any suitable combination of the above.

In a possible implementation, the disclosure may also be implemented in a form of a program product. The program product includes program codes. When the program product is run on a terminal device, the program codes cause the terminal device to execute the method for data transmission in implementation 1, implementation 2, or implementation 3.

The program codes for implementing the disclosure may be written in any combination of one or more programming languages. The program codes may be executed entirely on UE, executed partly on the UE, executed as a separate software package, executed partly on the UE and partly on a remote device, or executed entirely on the remote device.

A technical problem to-be-solved in the disclosure is to overcome the deficiencies of affecting service and user experience due to long time consumption for UL grant request in the related art, and therefore, methods and systems for data transmission, a terminal, and a storage medium are provided to improve user experience.

In the disclosure, the above technical problem is solved through the following technical solutions.

A first aspect of the disclosure provides a method for data transmission. The method includes: receiving SR configuration information transmitted by a BS, the SR configuration information containing a maximum number of SR transmissions; adjusting the maximum number of SR transmissions according to a priority of data to-be-transmitted; and transmitting an SR to request a UL grant resource for transmission of the data to-be-transmitted, and initiating a random access request to re-request the UL grant resource in response to a number of SR transmissions reaching the maximum number of SR transmissions.

In an implementation, adjusting the maximum number of SR transmissions according to the priority of the data to-be-transmitted includes: decreasing the maximum number of SR transmissions, in response to the priority of the data to-be-transmitted being higher than a preset level.

In an implementation, the SR configuration information further contains an SR period, and adjusting the maximum number of SR transmissions according to the priority of the data to-be-transmitted includes: calculating a target number of transmissions according to a preset timeout duration and the SR period, in response to the priority of the data to-be-transmitted being higher than a preset level; and adjusting the maximum number of SR transmissions to the target number of transmissions.

In an implementation, the method further includes: receiving random access configuration information transmitted by the BS, where the random access configuration information contains a maximum number of preamble transmissions; and adjusting the maximum number of preamble transmissions according to the priority of the data to-be-transmitted. Initiating the random access request to re-request the UL grant resource includes: initiating RRC connection re-establishment, in response to a number of preamble transmissions reaching the maximum number of preamble transmissions.

In an implementation, adjusting the maximum number of preamble transmissions according to the priority of the data to-be-transmitted includes: decreasing the maximum number of preamble transmissions, in response to the priority of the data to-be-transmitted being higher than a preset level.

A second aspect of the disclosure provides a method for data transmission. The method includes: receiving random access configuration information transmitted by a BS, the random access configuration information containing a maximum number of preamble transmissions; adjusting the maximum number of preamble transmissions according to a priority of data to-be-transmitted; and initiating a random access request to request a UL grant resource for transmission of the data to-be-transmitted, and initiating RRC connection re-establishment in response to a number of preamble transmissions reaching the maximum number of preamble transmissions.

In an implementation, adjusting the maximum number of preamble transmissions according to the priority of the data to-be-transmitted includes: decreasing the maximum number of preamble transmissions, in response to the priority of the data to-be-transmitted being higher than a preset level.

In an implementation, the method further includes: receiving SR configuration information transmitted by the BS, where the SR configuration information contains a maximum number of SR transmissions; adjusting the maximum number of SR transmissions according to the priority of the data to-be-transmitted; and transmitting an SR to request the UL grant resource for transmission of the data to-be-transmitted, and initiating the random access request to re-request the UL grant resource in response to a number of SR transmissions reaching the maximum number of SR transmissions.

In an implementation, adjusting the maximum number of SR transmissions according to the priority of the data to-be-transmitted includes: decreasing the maximum number of SR transmissions, in response to the priority of the data to-be-transmitted being higher than a preset level.

In an implementation, the SR configuration information further contains an SR period, and adjusting the maximum number of SR transmissions according to the priority of the data to-be-transmitted includes: calculating a target number of transmissions according to a preset timeout duration and the SR period, in response to the priority of the data to-be-transmitted being higher than a preset level; and adjusting the maximum number of SR transmissions to the target number of transmissions.

A third aspect of the disclosure provides a system for data transmission. The system includes a receiving module, an adjusting module, and a transmitting module. The receiving module is configured to receive SR configuration information transmitted by a BS, the SR configuration information containing a maximum number of SR transmissions. The adjusting module is configured to adjust the maximum number of SR transmissions according to a priority of data to-be-transmitted. The transmitting module is configured to transmit an SR to request a UL grant resource for transmission of the data to-be-transmitted, and initiate a random access request to re-request the UL grant resource in response to a number of SR transmissions reaching the maximum number of SR transmissions.

In an implementation, the adjusting module is specifically configured to decrease the maximum number of SR transmissions, in response to the priority of the data to-be-transmitted being higher than a preset level.

In an implementation, the SR configuration information further contains an SR period, and the adjusting module specifically includes a judging unit, a calculation unit, and an adjusting unit. The judging unit is configured to determine whether the priority of the data to-be-transmitted is higher than a preset level, and call the calculation unit in response to the priority of the data to-be-transmitted being higher than the preset level. The calculation unit is configured to calculate a target number of transmissions according to a preset timeout duration and the SR period. The adjusting unit is configured to adjust the maximum number of SR transmissions to the target number of transmissions.

In an implementation, the receiving module is further configured to receive random access configuration information transmitted by the BS, where the random access configuration information contains a maximum number of preamble transmissions. The adjusting module is further configured to adjust the maximum number of preamble transmissions according to the priority of the data to-be-transmitted. The transmitting module is further configured to initiate RRC connection re-establishment, in response to a number of preamble transmissions reaching the maximum number of preamble transmissions.

In an implementation, the adjusting module is specifically configured to decrease the maximum number of preamble transmissions, in response to the priority of the data to-be-transmitted being higher than a preset level.

A fourth aspect of the disclosure provides a system for data transmission. The system includes a receiving module, an adjusting module, and a transmitting module. The receiving module is configured to receive random access configuration information transmitted by a BS, the random access configuration information containing a maximum number of preamble transmissions. The adjusting module is configured to adjust the maximum number of preamble transmissions according to a priority of data to-be-transmitted. The transmitting module is configured to initiate a random access request to request a UL grant resource for transmission of the data to-be-transmitted, and initiate RRC connection re-establishment in response to a number of preamble transmissions reaching the maximum number of preamble transmissions.

In an implementation, the adjusting module is specifically configured to decrease the maximum number of preamble transmissions, in response to the priority of the data to-be-transmitted being higher than a preset level.

In an implementation, the receiving module is further configured to receive SR configuration information transmitted by the BS, where the SR configuration information contains a maximum number of SR transmissions; the adjusting module is further configured to adjust the maximum number of SR transmissions according to the priority of the data to-be-transmitted; and the transmitting module is further configured to transmit an SR to request the UL grant resource for transmission of the data to-be-transmitted, and initiate the random access request to re-request the UL grant resource in response to a number of SR transmissions reaching the maximum number of SR transmissions.

In an implementation, the adjusting module is specifically configured to decrease the maximum number of SR transmissions, in response to the priority of the data to-be-transmitted being higher than a preset level.

In an implementation, the SR configuration information further contains an SR period, and the adjusting module specifically includes a judging unit, a calculation unit, and an adjusting unit. The judging unit is configured to determine whether the priority of the data to-be-transmitted is higher than a preset level, and call the calculation unit in response to the priority of the data to-be-transmitted being higher than the preset level. The calculation unit is configured to calculate a target number of transmissions according to a preset timeout duration and the SR period. The adjusting unit is configured to adjust the maximum number of SR transmissions to the target number of transmissions.

A fifth aspect of the disclosure provides a terminal. The terminal includes at least one processor and a memory. The memory is in communication connection with the at least one processor, and stores instructions executable by the at least one processor. The instructions, when executed by the at least one processor, are operable with the at least one processor to execute the method for data transmission in the first aspect or the second aspect.

A sixth aspect of the disclosure provides anon-transitory computer-readable storage medium. The non-transitory computer-readable storage medium stores computer instructions which are operable with a computer to execute the method for data transmission in the first aspect or the second aspect.

While specific implementations of the disclosure have been depicted above, it will be understood by those skilled in the art that the above implementations are illustrative merely, and the scope of the disclosure is defined by the appended claims. Various changes and modifications may be made by those skilled in the art without departing from the principle and spirit of the disclosure, and such changes and modifications, however, shall all be encompassed within the protection scope of the disclosure.

1. A method for data transmission, performed by a terminal and comprising:
receiving scheduling request (SR) configuration information transmitted by a base station (BS), the SR configuration information containing a maximum number of SR transmissions;
adjusting the maximum number of SR transmissions according to a priority of data to-be-transmitted; and
transmitting an SR to request an uplink (UL) grant resource for transmission of the data to-be-transmitted, and initiating a random access request to re-request the UL grant resource in response to a number of SR transmissions reaching the maximum number of SR transmissions.

2. The method of claim 1, wherein adjusting the maximum number of SR transmissions according to the priority of the data to-be-transmitted comprises:
decreasing the maximum number of SR transmissions, in response to the priority of the data to-be-transmitted being higher than a preset level.

3. The method of claim 1, wherein the SR configuration information further contains an SR period, and adjusting the maximum number of SR transmissions according to the priority of the data to-be-transmitted comprises:
calculating a target number of transmissions according to a preset timeout duration and the SR period, in response to the priority of the data to-be-transmitted being higher than a preset level; and
adjusting the maximum number of SR transmissions to the target number of transmissions.

4. The method of claim 1, further comprising:
receiving random access configuration information transmitted by the BS, wherein the random access configuration information contains a maximum number of preamble transmissions; and
adjusting the maximum number of preamble transmissions according to the priority of the data to-be-transmitted.

5. The method of claim 4, wherein adjusting the maximum number of preamble transmissions according to the priority of the data to-be-transmitted comprises:
decreasing the maximum number of preamble transmissions, in response to the priority of the data to-be-transmitted being higher than a preset level.

6-20. (canceled)

21. A terminal, comprising:
a transceiver;
at least one processor, in communication connection with the transceiver; and
a memory, in communication connection with the at least one processor and storing instructions executable by the at least one processor;
the instructions, when executed by the at least one processor, being operable with the at least one processor to:
cause the transceiver to receive scheduling request (SR) configuration information transmitted by a base station (BS), the SR configuration information containing a maximum number of SR transmissions;
adjust the maximum number of SR transmissions according to a priority of data to-be-transmitted; and
cause the transceiver to transmit an SR to request an uplink (UL) grant resource for transmission of the data to-be-transmitted, and initiate a random access request to re-request the UL grant resource in response to a number of SR transmissions reaching the maximum number of SR transmissions.

22. (canceled)

23. A chip, comprising a processor configured to invoke and run programs stored in a memory to cause a device equipped with the chip to:
receive scheduling request (SR) configuration information transmitted by a base station (BS), the SR configuration information containing a maximum number of SR transmissions;
adjust the maximum number of SR transmissions according to a priority of data to-be-transmitted; and
transmit an SR to request an uplink (UL) grant resource for transmission of the data to-be-transmitted, and initiate a random access request to re-request the UL grant resource in response to a number of SR transmissions reaching the maximum number of SR transmissions.

24. The method of claim 4, wherein initiating the random access request to re-request the UL grant resource comprises:
initiating radio resource control (RRC) connection re-establishment, in response to a number of preamble transmissions reaching the maximum number of preamble transmissions.

25. The terminal of claim 21, wherein the at least one processor configured to adjust the maximum number of SR transmissions according to the priority of the data to-be-transmitted is configured to:
decrease the maximum number of SR transmissions, in response to the priority of the data to-be-transmitted being higher than a preset level.

26. The terminal of claim 21, wherein the SR configuration information further contains an SR period, and the at least one processor configured to adjust the maximum number of SR transmissions according to the priority of the data to-be-transmitted is configured to:
calculate a target number of transmissions according to a preset timeout duration and the SR period, in response to the priority of the data to-be-transmitted being higher than a preset level; and
adjust the maximum number of SR transmissions to the target number of transmissions.

27. The terminal of claim 21, wherein the at least one processor is further configured to:
cause the transceiver to receive random access configuration information transmitted by the BS, wherein the random access configuration information contains a maximum number of preamble transmissions; and
adjust the maximum number of preamble transmissions according to the priority of the data to-be-transmitted.

28. The terminal of claim 27, wherein the at least one processor configured to initiate the random access request to re-request the UL grant resource is configured to:
initiate radio resource control (RRC) connection re-establishment, in response to a number of preamble transmissions reaching the maximum number of preamble transmissions.

29. The terminal of claim 27, wherein the at least one processor configured to adjust the maximum number of preamble transmissions according to the priority of the data to-be-transmitted is configured to:
decrease the maximum number of preamble transmissions, in response to the priority of the data to-be-transmitted being higher than a preset level.

30. The chip of claim 23, wherein in terms of adjusting the maximum number of SR transmissions according to the priority of the data to-be-transmitted, the processor is configured to invoke and run the programs stored in the memory to cause the device equipped with the chip to:
decrease the maximum number of SR transmissions, in response to the priority of the data to-be-transmitted being higher than a preset level.

31. The chip of claim 23, wherein the SR configuration information further contains an SR period, and in terms of adjusting the maximum number of SR transmissions according to the priority of the data to-be-transmitted, the processor is configured to invoke and run the programs stored in the memory to cause the device equipped with the chip to:
calculate a target number of transmissions according to a preset timeout duration and the SR period, in response to the priority of the data to-be-transmitted being higher than a preset level; and
adjust the maximum number of SR transmissions to the target number of transmissions.

32. The chip of claim 23, wherein the processor is further configured to invoke and run the programs stored in the memory to cause the device equipped with the chip to:
receive random access configuration information transmitted by the BS, wherein the random access configuration information contains a maximum number of preamble transmissions; and
adjust the maximum number of preamble transmissions according to the priority of the data to-be-transmitted.

33. The chip of claim 32, wherein in terms of initiating the random access request to re-request the UL grant resource, the processor is configured to invoke and run the programs stored in the memory to cause the device equipped with the chip to:
initiate radio resource control (RRC) connection re-establishment, in response to a number of preamble transmissions reaching the maximum number of preamble transmissions.

34. The chip of claim 32, wherein in terms of adjusting the maximum number of preamble transmissions according to the priority of the data to-be-transmitted, the processor is configured to invoke and run the programs stored in the memory to cause the device equipped with the chip to:
decrease the maximum number of preamble transmissions, in response to the priority of the data to-be-transmitted being higher than a preset level.
